(19) United States
(12) Patent Application Publication
(10) Pub. No.: US 2008/0208665 A1
(43) Pub. Date: Aug. 28, 2008

(54) Organizational project management maturity development methods and systems

(76) Inventors: Larry Bull, Phoenixville, PA (US); Claudia M. Baca, Lakewood, CO (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/709,723

(22) Filed: Feb. 22, 2007

(51) Int. Cl. G06Q 90/00

(52) U.S. Cl. 705/8

(57) ABSTRACT

Methods and computer program products for developing an organization's project management skills through assessment of its project management maturity based on a set of organizations project management best practices is disclosed. To assess an organization's project management maturity, an assessment scope is defined within a set of organizational project management best practices where each best practice includes two or more incremental capabilities that aggregate to that best practice. Questions are selected that correspond to capabilities within the defined assessment scope and answers to the selected questions are received from one or more organizational roles. The organization's project management maturity is then assessed for the defined assessment scope responsive to the received answers in order to develop the organization's project management maturity.

### FIELD OF THE INVENTION

The present invention relates to the field of project management and, more particularly, to methods and systems for developing the project management skills of an organization.

### BACKGROUND OF THE INVENTION

Organizational project management is the application of knowledge, skills, tools, and techniques to organizational and project activities to achieve the goals of an organization through projects, e.g., to complete projects on time and/or within budget.

Competition is presently increasing within most industries and professions. Many organizations have identified improvement in organizational project management as a way to increase their ability to successfully complete projects (e.g., on time and within budget) and to achieve organizational goals in order to cope with this competition.

### SUMMARY OF THE INVENTION

The present invention is embodied in improved methods and computer program products for developing an organization's project management skills through assessment of its project management maturity based on a set of organizational project management best practices. An organization's project management maturity is assessed by defining an assessment scope within the set of organizational project management best practices where each best practice includes two or more incremental capabilities that aggregate to that best practice. Questions are selected that correspond to capabilities within the defined assessment scope and answers to the selected questions are received from one or more organizational roles. The organization's project management maturity is then assessed for the defined assessment scope responsive to the received answers in order to develop the organization's project management skills.

### DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. This emphasizes that according to common practice, the various features of the drawings are not drawn to scale. On the contrary, the dimensions of the various features are arbitrarily expanded or reduced for clarity. Included in the drawings are the following figures:

FIG. 1 is a flow diagram depicting a known relationship of best practices and their constituent capabilities and key performance indicators (KPIs);

FIG. 2 is an illustration of a known exemplary best practice and its constituent capabilities, outcomes, and key performance indicators (KPIs);

FIG. 3 is a graph depicting a known relationship of organizational project management maturity along a continuum;

FIG. 4 is a block diagram of an exemplary system for assessing an organization's project management maturity in accordance with aspects of the present invention;

FIG. 5 is a flow chart of exemplary steps for assessing and developing an organization's project management maturity in accordance with aspects of the present invention;

FIG. 6 is an illustration of exemplary questions for use in assessing an organization's project management maturity in accordance with aspects of the present invention;

FIGS. 7A, 7B, and 7C are graphs representing best practices maturity scores for best practices achieved in accordance with aspects of the present invention;

FIGS. 8A, 8B, and 8C are graphs representing best practices maturity scores for best practices not achieved in accordance with aspects of the present invention;

FIGS. 9A, 9B, and 9C are graphs representing capabilities maturity scores for capabilities achieved in accordance with aspects of the present invention;

FIGS. 10A, 10B, and 10C are graphs representing capabilities maturity scores for capabilities not achieved in accordance with aspects of the present invention; and

FIGS. 11A and 11B are illustrations of an exemplary report in accordance with aspects of the present invention.

### DETAILED DESCRIPTION OF THE INVENTION

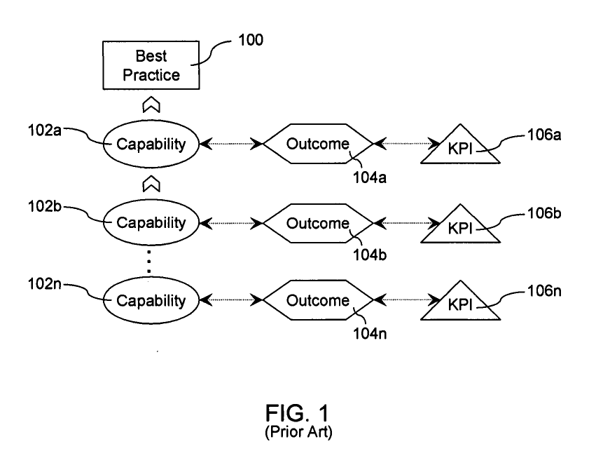

Referring generally to the drawings (FIGS. 1-11), in accordance with an exemplary embodiment, a method for assessing an organization's project management maturity to develop the organization's project management capabilities is provided. Assessment of an organization's project management maturity is based on a set of organizational project management best practices (and constituent capabilities), which are described in detail below. Organizational project management maturity is assessed by determining the number of best practices and/or capabilities achieved. The assessed organizational project management maturity may then be used to develop the organizations project management capabilities.

Referring now to the individual drawings in detail, FIG. 1 illustrates the relationship of a best practice 100 and its constituent capabilities 102a-n l used to assess an organization's project management maturity. In an exemplary embodiment, a best practice is an optimal way currently recognized by industry to achieve a stated goal or objective, e.g., the ability to deliver projects successfully, consistently, and predictably to implement organization strategies. In an exemplary embodiment, there are approximately 600 best practices, however, more or fewer best practices may be developed/employed.

Each best practice 100 includes one or more capabilities 102a-n, which are incremental steps for achieving the best practice. In an exemplary embodiment, each capability for a particular best practice 100 needs to be achieved in order to achieve that best practice 100. A capability 102 may be a specific competency for executing project management processes and/or delivering project management services and products. An individual capability is an incremental step leading to one or more best practices. In general, each capability 102 builds upon preceding capabilities 102 as illustrated in FIG. 1. In addition, there may be situations where dependencies appear to be joint in nature. For example, a capability 102n may generate an output that becomes an input into both a first capability 102a and a second capability 102b that lead to the same best practice 100. In such situations, these capabilities may be approached in parallel. Breaking down a best practice 100 into its constituent capabilities 102, and showing the dependencies among them, permits a detailed, orderly assessment, and provides a basis for later decisions related to improvement.

In an exemplary embodiment, each capability 102 has at least one observable and/or measurable associated outcome 104 that demonstrates the existence of that capability 102. The outcome 104 associated with a capability 102 may be measured using a key performance indicator (KPI) 106, which is a criterion by which an organization can determine, quantitatively or qualitatively, whether the outcome 104 associated with a capability 102 exists. A qualitative key performance indicator (KPI) 106 can be a rating based on the opinion of a person performing the assessment, e.g., an assessor/consultant. For quantitative KPIs 106, a form of metric is used to generate a rating. Exemplary metrics include an error count or customer satisfaction survey results. A quantitative or qualitative rating can be a binary rating (e.g., yes or no), a more complex rating (such as a scaled rating, e.g., 0-3), a monetary rating (such as financial return), or some other rating. Binary ratings (such as yes or no) and scaled ratings (such as 0-3) can be combined, e.g., by assigning “yes” equal to “3” and “no” equal to “0.” Each outcome 104 has an associated question, which will be described in further detail below.

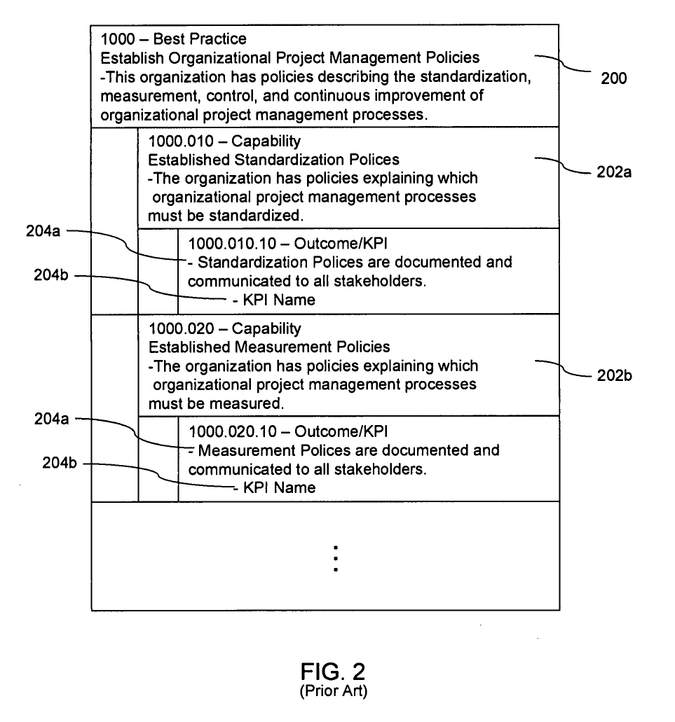

FIG. 2 depicts an exemplary best practice 200 and two capabilities 202a, b (among others, not shown) that lead to the best practice 200. Each capability 202a, b has at least one associated outcome 204a, and a KPI 204b by which that outcome is measured. Additional best practices and background material related to various aspects of the present invention may be found in Organizational Project Management Maturity Model (OPM3)—Knowledge Foundation published by the Project Management Institute, Inc. of Newtown Square, Pa., U.S.A., which is incorporated fully herein by reference.

In an exemplary embodiment, each best practice is categorized by at least one project management domain (herein domain) and, optionally, at least one stage of process improvement (herein stage). The domains may include project management, program management, and portfolio management. Project management relates to the management of temporary endeavors undertaken to create a unique product, service, or result. Program management relates to management of related projects. Portfolio management relates to the management of portfolios and projects. The stages may include standardize, measure, control, and improve, which are sequential stages of process improvement. Similar to best practices, capabilities may also be categorized by one or more domains and, optionally, stages.

Additionally, the best practices and/or capabilities may be categorized by one or more business roles, desired business results and/or as an organization enabler. Exemplary business roles include a manager, a CEO, a team member, etc. Exemplary desired business results include project outcome predictability and optimization of resources. Additional desired business results will be understood by one of skill in the art from the description herein. An organization enabler is a foundational best practice or capability that an organization should have in order to ensure that a meaningful assessment can be performed.

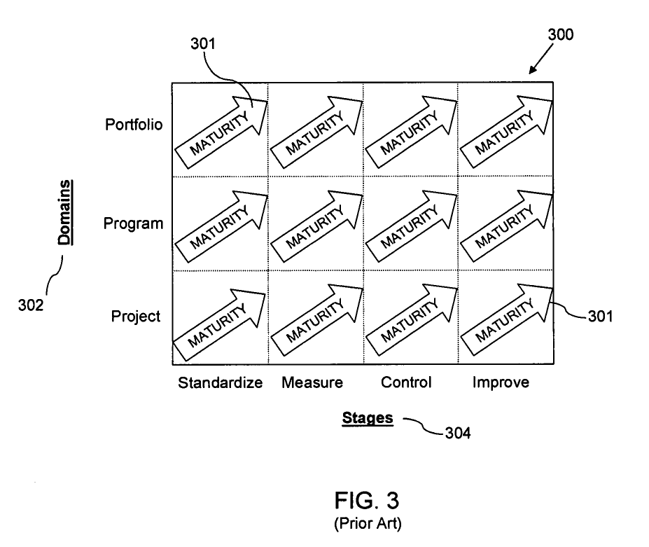

FIG. 3 illustrates a chart 300 depicting an exemplary relationship of organizational project management maturity 301 along a continuum of domains 302 and stages 304. Domains 302 refer to the three groups of organizational project management described above. Each domain includes a set of stages 304 which refer to the four stages of process improvement also described above. In accordance with an exemplary embodiment of the present invention, any one or more domains and stages may be selected for development, i.e., the organizational project management maturity development is multi-dimensional. For example, the project domain and standardize stage may be selected for maturity assessment within that particular area of interest. Alternatively, more than one area of interest may be selected for maturity assessment. For example, the program domain and control stage, and the portfolio domain and measure stage may be selected to evaluate multi-dimensions of maturity 301 within the selected areas of interest.

Organizational project management maturity can be measured in terms of the number and/or percentage of best practices and/or capabilities achieved within a particular domain 302 and/or stage 304. The number and/or percentage of best practices and capabilities achieved within each domain and respective stage is the conceptual framework for a maturity model, with constituent parts, that defines maturity in the area of interest. As illustrated in FIG. 3, for example, twelve constituent areas of interest may be measured. Maturity within each of these areas of interest may be measured by the percentage of best practices and capabilities achieved from a total possible number of best practices and capabilities in a particular domain and stage. Thus, this maturity model may describe a process whereby an organization can develop or achieve (conversely, not achieve) something desirable, such as a set of capabilities or best practices. This process can result in a more highly evolved organizational project management state (i.e., an organization that is more mature in project management).

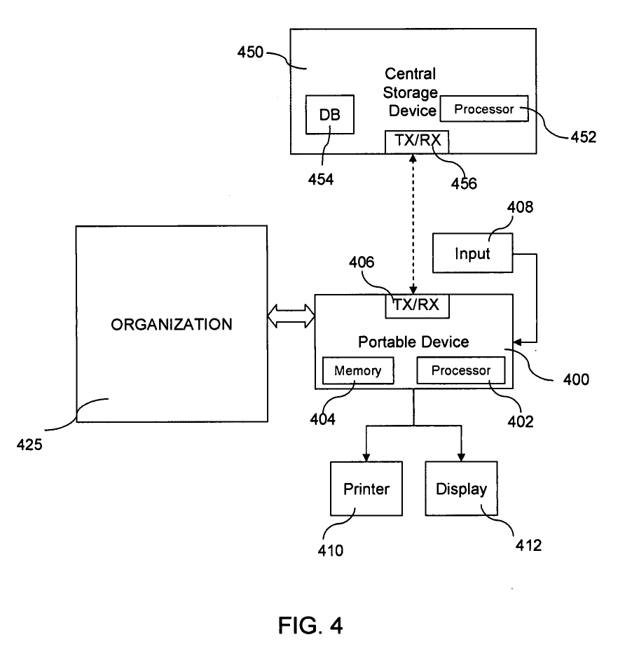

FIG. 4 illustrates an exemplary system for assessing an organization's project management maturity. The system includes a portable device 400 that may be transported by a person to an organization 425 to be assessed. The organization 425 to be assessed may be a non-profit, for-profit, private, public, or any other type of company/entity that implements projects.

The illustrated portable device 400 includes a processor 402 for performing instructions, a memory device 404 for storing data, and an optional transceiver 406 for communicating with an optional central storage device 450. The 30 memory may include one or more best practices and associated capabilities/outcomes/KPIs, which are associated with at least one domain or stage in an exemplary embodiment and optionally with one or more business roles or desired business results or as an organization enabler. Peripheral devices such as an input device 408 (e.g., keyboard, mouse, light pen, etc.), printer 410, and/or display 412 may be coupled to the portable device 400 to facilitate data entry and/or reporting. The portable device 400 may be a laptop computer, personal data assistant (PDA), or other suitable electronic device for processing information. Suitable devices for use as the portable device 400 and peripheral devices 408/410/412 and their configuration for use with the present invention will be understood by one of skill in the art from the description herein.

The illustrated central storage device 450 includes a processor 452 for performing instructions, a database 454 for storing data, and a transceiver 456 for communicating with the portable device 400. In an exemplary embodiment, the database 454 includes all available best practices and their associated capabilities/outcomes/KPIs/questions, with each best practice and capability individually associated with one or more domains and standards and optionally with one or more business roles or desired business results or as an organization enabler. A suitable device for use as central storage device 450 will be understood by one of skill in the art from the description herein.

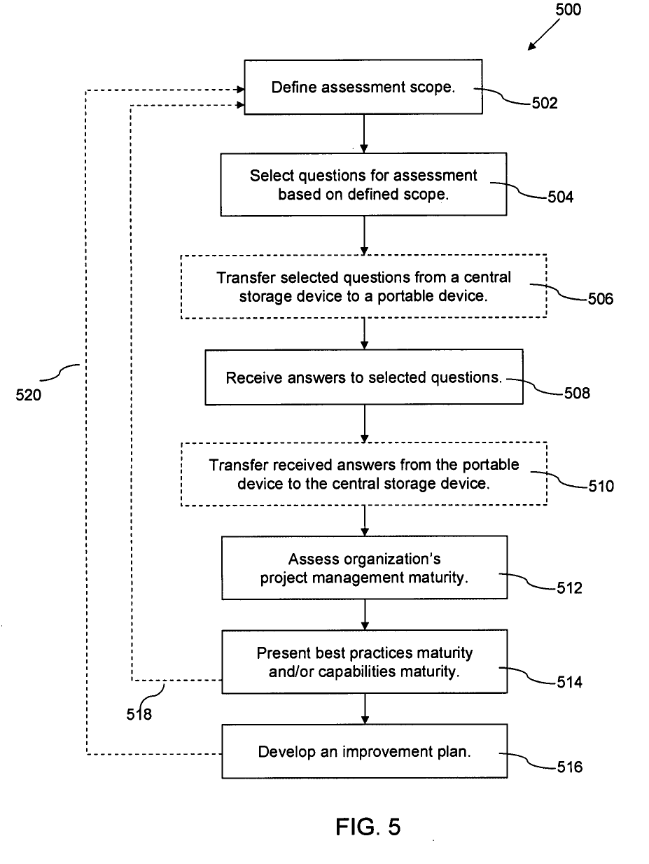

FIG. 5 is a flow chart 500 of exemplary steps for developing an organization's project management skills through assessment for its project management maturity based on a set of organizational project management best practices. In an exemplary embodiment, one or more of the steps are implemented in software that controls the computer. This software may be embodied in a computer readable medium, for example, a magnetic or optical disk, a memory-card or an audio frequency, radio-frequency, or optical carrier wave. The computer readable medium may be interpreted by the processor 402 to control the computer 400.

The method 500 will now be described with reference to FIGS. 1-4. At step 502, the assessment scope of an organization is defined. The assessment scope may be defined by selecting one or more domains 302 and/or stages 304 to be assessed in the organization 425. Alternatively, the assessment scope may be defined by selecting a business goal or result to be achieved.

In an exemplary embodiment, central storage device 450 is used to define the assessment scope based on input received from the portable device 400. Portable device 400 may present a person performing the assessment (i.e., the assessor) with an option to select domain or business goal. Selecting domain may result in the portable device displaying available domains and stages for selection (e.g., using check boxes) and selecting business goal may result in the portable device displaying available desired business results for selection. The assessor may base their selection on information received from a person at an organization 425. The selection of one or more of the available domains and stages or the selection of the one or more available business results is stored by the portable device (e.g., in memory 404). The stored selections are then transmitted to the central storage device 450, which processes the received selections to define the scope of the assessment (referred to herein as the scope selection). In an alternative exemplary embodiment, the portable device 400 may define the assessment scope without transferring the selections to the central storage device 400.

At step 504, questions for assessment of the organization are selected based on the scope defined in step 502. In an exemplary embodiment, the assessment questions are stored at the central storage device 450 in database 454. In accordance with this embodiment, the central storage device 450 automatically selects questions from the database 454 that are categorized in accordance with the scope selection. For example, if the project domain were selected, the central storage device 450 would select all questions within the database categorized as project questions. In an alternative exemplary embodiment, all questions may be stored within memory 404 of portable device 400. In accordance with this alternative embodiment, the processor 402 within the portable device 400 automatically selects questions from the memory 404 that are categorized in accordance with the scope selection. In an exemplary embodiment, questions categorized as organizational enablers are always selected for an assessment regardless of the selection scope.

In embodiments where the selection of questions is performed at the central storage device 450, the selected assessment questions are transferred from the central storage device 450 to the portable device 400 at step 506. The selected assessment questions may be transmitted by the transceiver 456 of the central storage device 450 and received by a transceiver 406 of the portable device 400. Maintaining the questions at the central storage device facilitates updating and adding best practices 100 and capabilities 102. Alternatively, step 506 may be omitted if assessment questions are selected by the portable device 400 from questions stored in memory 404.

At step 508, answers are received for the selected assessment questions. In an exemplary embodiment, the assessor transports the portable device 400 to the organization 425 to receive answers to the selected questions and transports the portable device from the organization 425 after the answers to the selected questions are received. Alternatively, or in conjunction with transporting the portable device to/from the facility, the assessor may receive answers to one or more of the selected questions via an alternative communication means, e.g., telephone, electronic mail, conventional mail, etc.

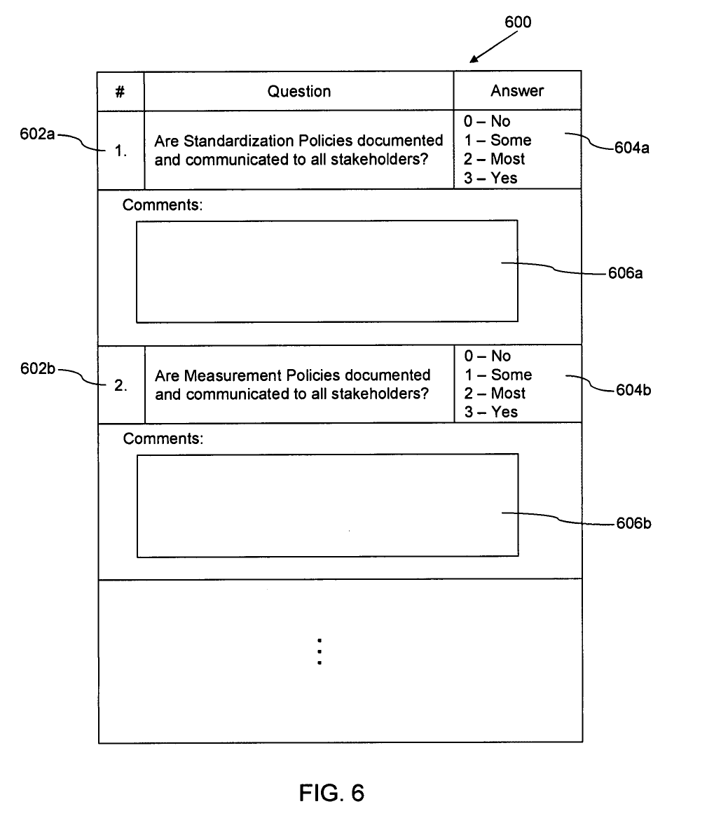

The assessor may query the person having the appropriate role (based on categorization of the questions) at the organization 425 for each of the selected questions and enter the answers received from that person directly into the portable device 400. The received answers for each question may include an answer selected from a set of existing possible choices for each question and/or a non-standardized (e.g., open-ended) answer entered in text by the person. The possible choices and/or a text entry field may be displayed by the portable device as described below with reference to FIG. 6 to facilitate entry of the received answer by the assessor.

In embodiments where the selection of questions is performed at the central storage device 450, the received answers may be transferred from the portable device 400 to the central storage device 450 at step 510. The information transmitted to the central storage device 450 may be stored/maintained in a central database 451 for processing. Storage of the received answers at the central storage device 450 enhances security and facilitates back-up and archiving of the received answers for future assessments. In an exemplary embodiment, information that may be used to identify the organization 425 may be maintained exclusively at the central database 451, with a numerical identifier or other known mechanism used to match the organization with the assessment information. In accordance with this embodiment, the identity of the organization may remain confidential in the event that the portable device is lost/stolen. Step 510 may be omitted if received answers are exclusively stored in memory 404 and/or processed by the portable device 400.

At step 512, the organization's project management maturity is assessed by the portable device 400 (e.g., if the answers are not transferred to the central storage device 450) and/or by the central storage device 450 (e.g., if the answers are transferred to the central storage device 450) based on the received answers. The assessment of an organization's project management maturity may include computing the number of best practices and/or the number capabilities achieved by an organization compared to the respective total number of best practices and/or capabilities within the defined assessment scope. As set forth above, in an exemplary embodiment, each capability for a particular best practice needs to be achieved in order to achieve that best practice. For example, assume that the scope identified ten best practices and that each of the identified best practice has four capabilities that is not shared with another best practice. If all the capabilities for five of the best practices are achieved and two of the capabilities for the other five best practices are achieved, the best practices maturity would be five out of ten (or 50%) and the capabilities maturity would be thirty out of forty (or 75%). The assessment may also include converting received answers based on qualitative observations into tangible quantitative results (e.g., scaling) such as point based scores (e.g., 0, 1, 2, 3) prior to computing the number of best practices and/or capabilities.

At step 514, the best practices maturity and/or capabilities maturity for the organization 425 may be presented by the portable device 400 in electronic format (e.g., on display 412) or in paper format (e.g., by printer 410) to an appropriate person within the organization 425. In embodiments where the organization's project management maturity is assessed by the central storage device 450, the assessment is transferred to the portable device 400 prior to presentation.

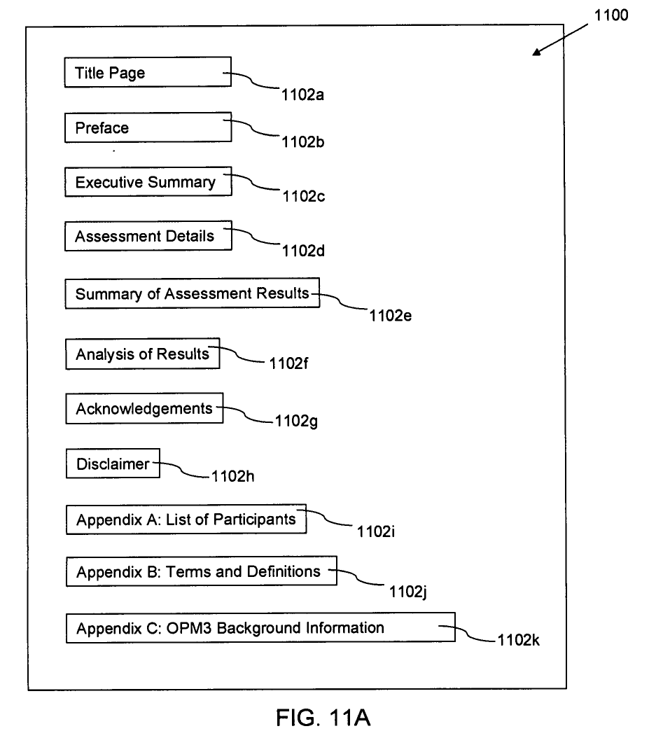

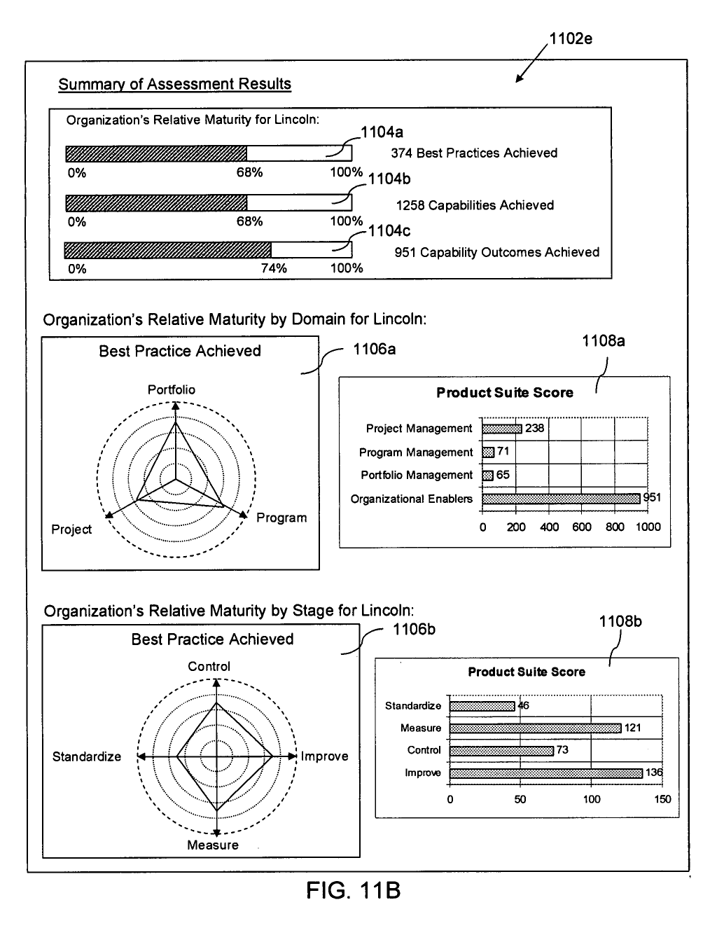

In an exemplary embodiment, the best practices maturity may be presented graphically and/or textually such as described below with reference to FIG. 11. For example, the best practices maturity and/or capabilities maturity may be presented as a best practice/ capability score in bar graphs, pie charts, figures, tables, or any other graphical or textual representation known by one of skill in the art, which are described in further detail below. The best practice maturity and/or capabilities maturity may also be presented as fully achieved best practice/capability scores categorized by one or more organizational project management domains (e.g., project, program, portfolio) or stages (e.g., standardize, measure, control, improve).

Dashed arrow 518 represents that the assessment performed according to steps 502 through 512 may be repeated, e.g., for another organization 425 within a multi-organizational entity. For example, a large corporation having offices in Chicago and New York with a purchasing department in each location may assess each location for comparison. In accordance with this embodiment, the presenting step 514 may present each assessment separately and/or combined one or more assessment to identify strengths and/or weaknesses within the multi-organizational entity. To facilitate comparison, it is desirable that each assessment to be combined have the same scope.

At step 516, an improvement plan is developed based on the assessment of the organization's project management maturity. In an exemplary embodiment, the improvement plan may include graphical and/or textual information based on the best practices and/or capabilities not achieved by an organization. The improvement plan may also include comments and suggestions entered by a business consultant based on the selected assessment questions. The graphical improvement plan may be presented in a format that is inversely related to the best practices maturity and/or capabilities maturity presented at step 514. The format may include computing the number of best practices and/or the number capabilities not achieved by an organization compared to the respective total number of best practices and/or capabilities within the defined assessment scope. The best practice and/or capabilities may be presented as best practice/capability not achieved scores categorized by one or more organizational project management domains (e.g., project, program, portfolio) or stages (e.g., standardize, measure, control, improve).

Dashed arrow 520 represents that after the improvement plan is developed, the assessment can be performed at a later date in order to determine if the improvement plan is assisting the organization in improving its organizational project management maturity.

FIG. 6 illustrates an exemplary questions 602a, b presented during an assessment (e.g., on display 412). The exemplary questions 602 correspond to selected best practices and/or capabilities that define the scope of the assessment. As illustrated in FIG. 6, answers 604a, 604b to questions may be selected from predetermined answer choices. The answers may be scaled quantitatively such that a “no” answer is awarded 0 points, a “some” answer is awarded 1 point, a “most” answer is awarded 2 points, and a “yes” answer is awarded 3 points. It is contemplated that the numerical scale for each answer may be different, with a quantitative component incorporated for a particular answer. Input sections 606a, b may be provided to record additional qualitative or quantitative observations of an assessor. Comments and/or answers recorded in the open-ended input section 606 may provide additional information relevant for the assessment of best practices maturity and/or capabilities maturity.

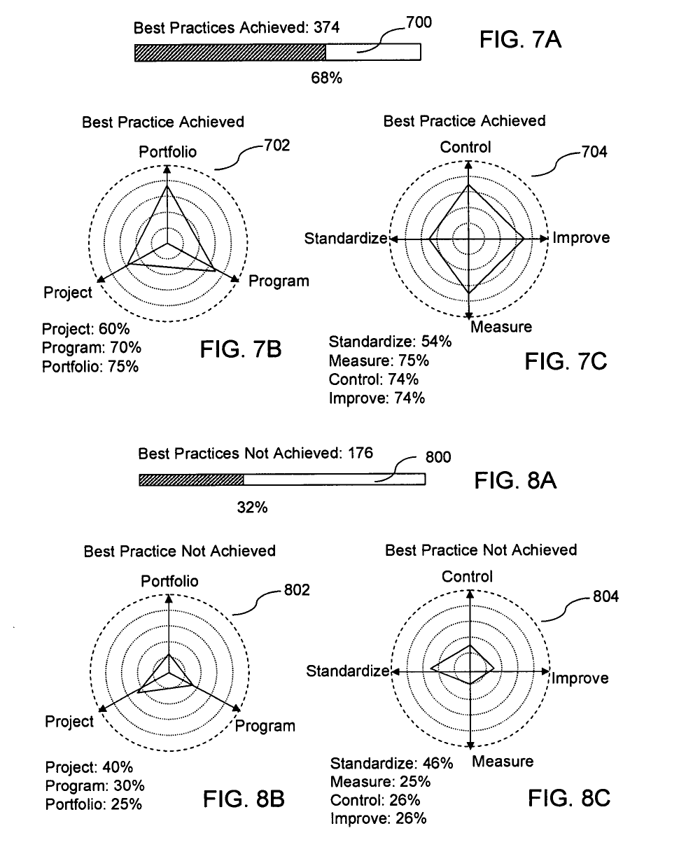

FIG. 7A is an exemplary graph 700 of a best practices maturity score based on the number of best practices fully achieved for a defined assessment scope along with a numerical value. The percentage of best practices achieved is also shown in FIG. 7A, which is the computed percentage out of a total of 550 possible best practices within the scope of the organization's project management domain in this example.

FIG. 7B is an exemplary spider diagram 702 showing the organization's best practices maturity in terms of each domain for analysis by an assessor or consultant, for example. In spider diagram 702 and the other spider diagrams described below, the center represents an achieved level of zero and the outer circle represents an achieved level of 100%. The best practices domain diagram 702 indicates an assessment of maturity in terms the percentage best practices achieved within each domains of organizational project management (e.g., project, program, portfolio). The percentages may also be broken down by stage as illustrated in exemplary spider diagram 704 in FIG. 7C.

The diagrams may be used by an assessor and/or consultant to identify organization project management strength and weaknesses that are not readily apparent. One might expect that the indicator of maturity would be higher for projects than for programs, and higher for programs than for the portfolio domain. However, one may find that the indicated maturity may not follow the expected pattern. For example, the assessment of portfolio management may be higher than expected. This may be due to the organization having some prioritization or planning processes and financial or legal controls in place. Likewise, the exemplary process management spider diagram 704 illustrated in FIG. 7C may not necessarily indicate a decreasing level of maturity, moving from standardize to measure, control, and continuously improve. For example, the organization may have several financial and legal controls in place, which may result in a higher maturity indication for controls than for measurement.

FIG. 8A is an exemplary graph 800 of a best practices maturity score as a percentage of best practices not achieved out of a total number of possible best practices in the organization's project management domain along with a numerical value. The number of best practices not achieved may indicate areas in which improvement is needed for increasing organizational project management maturity. This information may be used to develop an improvement plan. The percentage illustrated in graph 800 is the computed percentage of best practices not achieved out of a total of 550 possible best practices (i.e., the inverse of graph 700 in FIG. 7A).

FIG. 8B is an exemplary spider diagram 802 showing the organization's best practice maturity in terms of the percentage of best practices not achieved in each organizational project management domain. The percentages may also be broken down by stage as illustrated in exemplary spider diagram 804 in FIG. 8C.

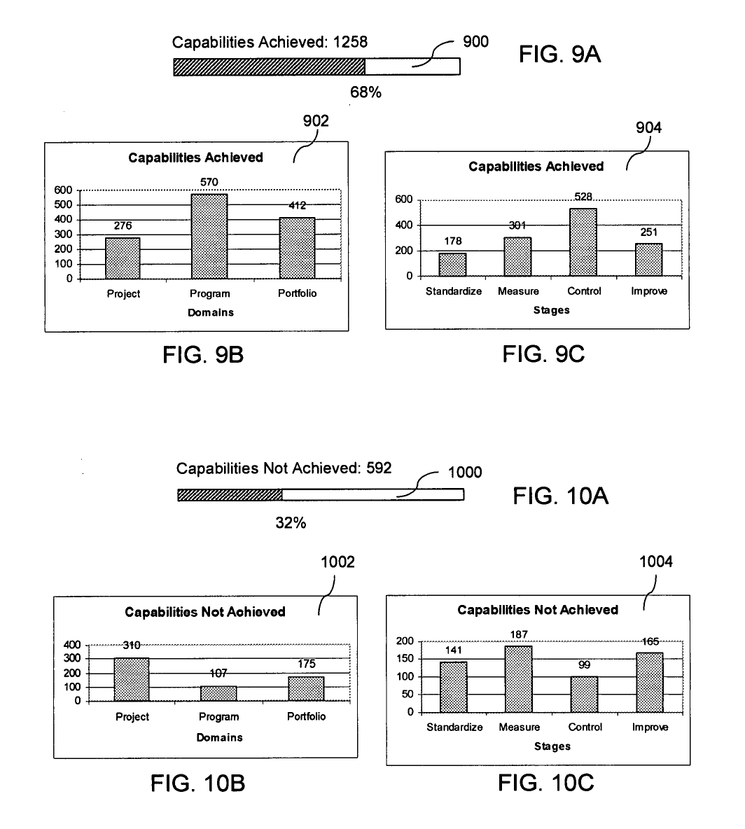

FIGS. 9A, 9B, and 9C are respective graphs 900, 902, and 904 illustrating a capabilities maturity assessment based on the number and percentage of capabilities achieved within the scope of the organization's project management domain. The exemplary graph 900 in FIG. 9A depicts a capabilities maturity score based on the number of capabilities achieved for a defined assessment scope along with a numerical value. The percentage of capabilities achieved is also shown in FIG. 9A, which is the computed percentage of capabilities achieved out of a total number of capabilities within the scope of the organization's project management domain in this example. The exemplary graph 902 in FIG. 9B depicts the organization's capabilities maturity in terms of each domain and the exemplary graph 904 in FIG. 9C depicts the organization's capabilities maturity in terms of each stage. As shown in FIG. 9A, the number of capabilities achieved is greater than the number of best practices achieved (see FIG. 7A) for a corresponding assessment scope. This is possible because each best practice may include two or more capabilities.

FIGS. 10A, 10B, and 10C are respective graphs 1000, 1002, and 1004 illustrating capabilities not achieved within the defined assessment scope for an organization. The exemplary graph 1000 in FIG. 10A depicts a capabilities maturity score based on the number of capabilities not achieved for a defined assessment scope along with a numerical value. The percentage of capabilities not achieved is also shown in FIG. 10A, which is the computed percentage of capabilities not achieved out of a total number of capabilities within the scope of the organization's project management domain in this example. The exemplary graph 1002 in FIG. 10B depicts the organization's capabilities that are not achieved in terms of each domain and the exemplary graph 1004 in FIG. 10C depicts the organization's capabilities that are not achieved in terms of each stage. The number of capabilities not achieved is higher than the number of best practices not achieved (see FIGS. 8A, 8B, 8C) for a corresponding assessment scope. The capabilities not achieved may be used to develop an improvement plan to achieve these capabilities and increase organizational project management maturity.

FIG. 11A depicts an exemplary report 1100 generated in accordance with the present invention. The report 1100 may be used to provide results for an individual assessment and/or merged assessments. The illustrated report 1100 includes exemplary content sections 1102a-k that may be automatically generated by portable device 400. Content section 1102a is a title page including a title for the report. Content section 1102b is a preface section including introductory remarks. Content section 1102c is an executive summary providing a brief summary of the report. Content section 1102d provides assessment details such as scope and individuals questioned during the assessment. Content section 1102e provides a summary of assessment results, which is presented in greater detail in FIG. 11B. Content section 1102f provides an analysis of results as interpreted by the assessor, for example. Content second 1102g is an acknowledgment section acknowledging individuals and/or groups within the organization 425 (FIG. 4) that assisted with the assessment. Content section 1102h is a disclaimer providing the limits of the assessment. Content section 1102i, j, and k are respective appendices that include additional information related to the assessment.

The content sections 1102 may be edited by a person such as a consultant or assessor to add, delete, and or reposition sections within the report 1100, e.g., using input device 408 of portable device 400. Each content section 1102 may include textual and/or graphical information pertaining to the results of the assessment.

FIG. 11B depicts the exemplary summary of assessment results section 1102e of FIG. 11A for providing a summary of the results for best practices maturity and/or capabilities maturity in greater detail. The illustrated section 1102e includes bar graphs 1104a-c depicting best practices achieved, capabilities achieved, and capability outcomes achieved, respectively. Additionally, spider diagrams 1106a, b are included for best practices achieved by domain and stage, respectively. Further, bar graphs 1108a, b are included that depict scoring broken down by domain (and organizational enablers) and by stage, respectively. Additionally graphs and diagrams may also by included, e.g., similar graphs and diagrams or capabilities.

Although the present invention has been particularly described in conjunction with specific embodiments, many alternatives, modifications, and variations will be apparent to those skilled in the art. It is therefore contemplated that the appended claims will embrace any such alternatives, modifications, and variations as falling within the true scope and spirit of the present invention.

What is claimed:

1. A method for developing an organization's project management skill based on a set of organizational project management best practices, the method comprising:
defining an assessment scope within the set of organizational project management best practices, each best practice comprised of two or more incremental capabilities that aggregate to that best practice;
selecting questions corresponding to capabilities within the defined assessment scope;
receiving answers to the selected questions from one or more organizational roles; and
assessing the organization's project management maturity for the defined assessment scope responsive to the received answers in order to develop the organization's project management skills.

2. The method of claim 1, further comprising:
presenting at least one of best practices maturity for the organization or capabilities maturity for the organization.

3. The method of claim 2, wherein the presenting includes:
displaying the at least one of best practices maturity for the organization or capabilities maturity for the organization on a display device.

4. The method of claim 2, wherein the best practices maturity is presented as a fully achieved best practice score.

5. The method of claim 2, wherein each best practice is categorized as at least one of project, program, or portfolio within a domain and wherein the presenting of the best practices maturity comprises graphically presenting a domain best practices maturity based on project, program, and portfolio.

6. The method of claim 2, wherein each best practice is categorized as at least one of standardize, control, measure, or improve within a stage and wherein the presenting of the best practices maturity comprises graphically presenting a stage best practices maturity based on standardize, control, measure, and improve.

7. The method of claim 2, wherein the capabilities maturity is presented as a points based capability score.

8. The method of claim 2, wherein each capability is categorized as at least one of project, program, or portfolio within a domain and wherein the presenting of the capabilities maturity comprises graphically presenting a domain capabilities maturity based on project, program, and portfolio.

9. The method of claim 2, wherein each capability is categorized as at least one of standardize, control, measure, or improve within a stage and wherein the presenting of the best practices maturity comprises graphically presenting a stage capabilities maturity based on standardize, control, measure, and improve.

10. The method of claim 1, wherein each question is categorized by domain, stage, desired business result, and role and wherein the defining comprises:
receiving a selection of either domain or business goal.

11. The method of claim 10, wherein the domain includes project, program, and portfolio; the stage includes standardize, measure, control, and improve; the role includes manager, CEO, and administrative assistant; and, if a domain selection is received, the defining further comprises:
receiving a selection of one or more of project, program, portfolio, standardize, measure, control and improve.

12. The method of claim 11, wherein the selecting comprises:
automatically matching the categorized questions to the received selections to select the questions.

13. The method of claim 10, wherein the desired business result includes project outcome predictability and optimization of resources.

14. The method of claim 10, wherein one or more questions are further categorized as an organization enabler and wherein the selecting includes selecting the one or more questions categorized as organization enablers regardless of the received selection.

15. The method of claim 1, further comprising:
developing an improvement plan for the organization based on the assessment of the organization's project management maturity.

16. The method of claim 15, wherein the assessment is presented in a first format and the improvement plan is presented in a second format that is inversely related to the first format.

17. The method of claim 1, further comprising:
transferring the selected questions from a central storage device to a portable device, wherein the receiving occurs at the portable device;
transferring the received answers from the portable device to the central storage device.

18. The method of claim 17, wherein information about the organization is maintained at the central storage device and not transferred to the portable device.

19. The method of claim 1, further comprising:
repeating the defining, selecting, receiving, and assessing for an other organization; and
combining the organization assessment with the other organization assessment.

20. A physical computer readable carrier including a computer program that causes a computer to perform the method according to claim 1.
